(19) United States
(12) Patent Application Publication
(10) Pub. No.: US 2024/0082807 A1
(43) Pub. Date: Mar. 14, 2024

(54) A SINGLE DOMINATING MODE MICROWAVE REACTOR

(71) Applicant: Organic Fuel Technology A/S, Aarhus C. (DK)

(72) Inventors: Jens Christian Pedersen, Aarhus C (DK); Poul Leth-Espensen, Aarhus C (DK); Anders Hjortshøj, Aarhus C (DK)

(21) Appl. No.: 18/261,984

(22) PCT Filed: Feb. 21, 2022
(86) PCT No.: PCT/EP2022/054262

§ 371 Date: Jul. 18, 2023

(30) Foreign Application Priority Data
Feb. 22, 2021 (DK) PA 2021 70084

(51) Int. Cl. B01J 19/12; B01J 19/00; C10G 1/08; C10G 1/10; H05B 6/70; H05B 6/80

(52) U.S. Cl. CPC B01J 19/126; B01J 19/0066; C10G 1/08; C10G 1/10; H05B 6/701; H05B 6/806; B01J 2219/1218; B01J 2219/1227; B01J 2219/1269; B01J 2219/1293; C10G 2300/1003; C10G 2300/1011

(57) ABSTRACT

The present invention relates to a single mode or single dominating mode microwave reactor, a single dominating mode microwave reactor system and a method of producing fuel, such as biofuel.

### FIELD OF THE INVENTION

The present invention relates to a single mode or single dominating mode microwave reactor, a single dominating mode microwave reactor system and a method of producing fuel.

### BACKGROUND OF THE INVENTION

Microwave energy has been in use for many applications for more than 50 years, from communication, food processing, and wood drying to chemical reactions and medical therapy. The areas, where microwave technology is applied, include drying, calcination, decomposition, powder synthesis, sintering, and chemical process control.

Microwave heating technology, when applied to chemical reactions, represents a sustainable “green” chemistry by utilizing safer solvents and reaction conditions, minimizing the potential for accidents, preventing the waste of products, and minimizing the time of reactions. For instance, in different microwave frequencies, it is possible to efficiently synthesize nanoparticles at much shorter times than when relying on conventional synthesis, without the use of microwaves.

Compared with other methods that do not use microwaves, the use of microwave heating reduces reactions time and in general improves the homogeneity of the synthesis sludge.

However, current microwave system solutions do not always deliver evenly distributed microwave radiations and creates some type of localized overheating, with respect to the rest of the sample's volume, also called “hot spot”. Presence of hot spots indicates the inhomogeneous dissipation of microwave energy through selective heating in different parts of the material due to the uneven distribution of the electromagnetic field within a homogeneous sample.

Hence, there is a need for microwave flow reactor that allow for more homogenous heating, impart better process control and energy efficiency and allow for larger-scale applications.

An improved microwave reactor providing more homogenous electromagnetic field distribution would thus be advantageous, and in particular, a more efficient microwave reactor able to distribute more evenly an electromagnetic field within the material to be processed, would be advantageous.

### OBJECT OF THE INVENTION

An object of the present invention is to provide a microwave flow reactor that allow for the distribution of microwave energy evenly within the material to be processed.

A further object of the present invention may be seen has to provide a microwave reactor ensuring uniform microwave radiation within the material to be processed.

An object of the present invention may also be seen as to provide an alternative to the prior art.

In particular, it may be seen as an object of the present invention to provide a single-mode or single dominating mode microwave flow reactor that solves the above-mentioned problems of the prior art by suppressing the propagation of over-modes, such that the material to be processed receive a more even distribution of Electric field (E-field).

### SUMMARY OF THE INVENTION

Thus, the above-described object and several other objects are intended to be obtained in a first aspect of the invention by providing a single dominating mode microwave reactor comprising: a reactor chamber; at least one means for feeding single mode microwaves into the reactor chamber connected to the reactor chamber.

In general, electromagnetic waves can travel along waveguides using a number of different modes.

As to rectangular waveguides, there two types of waves in a hollow waveguide with only one conductor: transverse electric (TE) and transverse magnetic (TM) waves.

Transverse electric (TE) modes are characterized by having only a magnetic field along the direction of propagation no electric field in the direction of propagation. TE modes have the electric vector (E) being always perpendicular to the direction of propagation.

The fundamental mode of a waveguide is the mode that has the lowest cut-off frequency. For a rectangular waveguide, the TE₁₀ mode is the fundamental mode.

Single mode or single dominating mode microwave reactors is herein defined as a reactor in which microwaves propagates substantially in a single mode.

The single mode or single dominating fundamental mode of propagation maybe a transverse electric (TE) mode.

In that, in some embodiments, the microwave reactor of the invention effectively suppress and control the modes of propagation different from the fundamental mode.

In some other embodiments, the at least one means for feeding single mode microwaves comprises means for transmitting microwaves having a microwaves inlet and a microwaves outlet and filtering means.

Means for transmitting microwaves may be any means allowing for microwave propagation.

In some embodiments, the means for transmitting microwaves is or comprises a horn antenna.

Horn antennas or microwave horns are antennas that consist of a flaring metal waveguide shaped like a horn to direct radio waves in a beam. These antennas are generally used as feed antennas and are also referred herein as feed horns.

The interface to the horn antenna maybe a waveguide that operates in its fundamental TE₁₀ mode.

The waveguide may be a standard 3.4 inches waveguide such as a WR340 waveguide. However, waveguide having different dimensions may be used by applying opportune adjustments.

In some other embodiments, the means for transmitting microwaves is or comprises a planar microwave antenna.

In some embodiments, the filtering means is or comprises a mode filter.

The filtering means have the function of cancelling or attenuating the presence of possible over modes.

The mode filter may comprise metal rods or cylinders separated from each other and located at the microwaves outlet of the means for transmitting microwaves, such as the horn antenna.

The mode filter is located at the outlet of the means for transmitting microwaves, i.e. at the end of the means for transmitting microwaves, at the microwave inlet of the reactor chamber.

In the absence of the mode filter, several over-modes can exist. The model filter has the ability of cancelling or attenuating the over modes that have an E-field component parallel to the metal rods or metal cylinders of the mode filter.

The metal rods or cylinders may be separated from each other by less than a quarter wavelength of transmitted microwaves in the direction of propagation of the microwaves and by less than a half wavelength of transmitted microwaves in a direction orthogonal to the direction of propagation of the microwaves.

As for the direction of propagation of the microwaves, it is intended as the direction of propagation of the microwaves when the microwave reactor is used and microwaves are fed to the reactor through means for transmitting microwaves.

In some embodiments, the metal rods or cylinders are separated from each other by 3 mm in the direction of propagation of the microwaves and by 15 mm in a direction orthogonal to the direction of propagation of the microwaves.

In some embodiments, the reactor chamber is a cylindrical reactor chamber.

The microwave reactor of the invention may be adapted to process different type of materials and thus can be used to performed different type of reactions.

The reactor chamber is the internal cavity of the reactor, where the reactions to be performed occur.

In some further embodiments, the single dominating mode microwave reactor according to the first aspect of the invention further comprises a rotating device located within the reactor chamber. The rotating device may be configured to mix the material to be processed within the reactor chamber, thereby ensuring uniform microwave radiation onto the material to be processed.

The rotating device is adapted to stir and/or mix the material to be processed within the reactor chamber. This presence of means for moving and turning the processed material safeguards the uniform distribution of the E-field onto the material to be processed.

In some embodiments, the rotating device is or comprises an impeller.

The rotating device may also comprise helical coils further promoting an efficient turbulence under agitation, thus leading to a more uniform blending.

In some further embodiments, the rotating device comprises helical blades attached to a rotating shaft.

The rotating device coupled to the presence of the mode filter allows for a near even distribution of the E-field with the material to be processed with the advantage of improving the reaction efficiency within the reactor chamber.

In a second aspect, the invention relates to a single dominating mode microwave reactor system comprising: a single dominating mode microwave reactor according to the first aspect of the invention; a microwave generator connected to the single dominating mode microwave reactor.

The single dominating mode microwave reactor system thus comprises one or more sources of microwaves, such as magnetrons, interfaced to the means for transmitting single mode microwaves, such as horns antennas.

In some embodiments, the single dominating mode microwave reactor system comprises two or more microwave generators with individual mode filters.

These embodiments may also be referred to as dual systems.

The need of coupling between microwave generators in systems with two or more microwave reactors is minimized by suppression of overmodes.

The single dominating mode microwave reactor system may be used for several applications in which it may be advantageous to have an even distribution of electrical field within the material to be processed.

For example, the single dominating mode microwave reactor system of the invention may be used in several microwave-heating applications for environmental and medical uses, food processing, ink and paint as well as in wood treatments and agricultural uses.

The single dominating mode microwave reactor system of the invention may also be used in microwave chemistry and material processing related to inorganic or organic synthesis, for biochemistry reaction, polymer related processes as well for catalytic chemistry processing.

In a third aspect, the invention relates to a method of producing fuel, the method comprising:
providing a feedstock;
transferring the feedstock into a microwave reactor chamber of a microwave reactor according to first aspect of the invention or of a microwave reactor system according to the second aspect of the invention;
subjecting the feedstock to a processing sequence by applying microwave energy thereto, thereby producing a distributed generation of electrical field onto the feedstock.

Preferably, the feedstock is mixed with a catalyst prior to transferring the feedstock into a microwave reactor or microwave reactor system. The processing sequence may preferably controlled by moving said feedstock or mixture of catalyst and feedstock through said microwave reactor past static microwave generators. The process is preferably solvent free. The process may be performed in batches or as a continuous process. The temperature of the feedstock or catalyst-feedstock mixture is raised to a temperature between 80-500° C. during processing, such as preferably 100-480° C., 150-450° C., 200-400° C., such as 250-380° C. The operating pressure in the reactor is preferably between 50-130 kPa to obtain the fuel. The fuel may preferably be a biofuel. Preferably the processing sequence where microwave energy is applied to the feedstock is 1-200 minutes, such as 5-100 minutes, 10-80 minutes, preferably 15-70 minutes.

The feedstock may preferably be a solid feedstock. Preferably the feedstock is a renewable feedstock, and/or a feedstock comprising polymerized hydrocarbon chains, such as biomass feedstock. Feedstocks may be selected from the list consisting of straw, slurry, slurry fibers, rape cakes, energy willow, nut shells, wood chips, wood pellets, algae, sludge, pressure-creosoted wood, rubber or any combination thereof. Rubber may include rubber waste, including used tyres. Tyres may be shredded. Preferably organic feedstocks are pre-treated, including dried to comprise an acceptable amount of water, such as less than 15%, 10% or 5%. Pretreatment may include drying, heating, shredding, extruding, and/or pelleting.

The catalyst may preferably be a microwave absorbing agent, such as an aluminosilicate mineral, preferably a zeolite. The catalyst-feedstock mixture may preferably comprise less than 15% (w/w) catalyst, such as less than 10%, 5%, 3%, 2%, such as preferably less than 1% (w/w) catalyst. The catalyst may be present in the mixture in a range from 0.01-15% (w/w), such as 0.1-10%, 0.1-5%, 0.2-3%, such as 0.5-2% (w/w).

The main idea of the invention relates to a microwave reactor that distributes the E-field evenly on the material surface to be processed by effectively controlling and suppressing the propagation of over-modes, such that, the material is processed with an evenly distributed field of energy.

The first and other aspects and embodiments of the present invention may each be combined with any of the other aspects and embodiments. These and other aspects of the invention will be apparent from and elucidated with reference to the embodiments described hereinafter.

### BRIEF DESCRIPTION OF THE FIGURES

The single dominating mode microwave reactor, single dominating mode microwave reactor system and the method of producing biofuel according to some of the aspects of the invention will now be described in more details with regard to the accompanying figures. The figures show one way of implementing the present invention and are not to be construed as being limiting to other possible embodiments falling within the scope of the attached claim set.

References to x, y and z directions within the figures relates to microwave propagation direction, being z a vector indicating the direction of propagation of the microwave and x and y perpendicular vectors to the vector z.

FIG. 1A is an illustration of the single dominating mode microwave reactor according to some embodiments of the invention.

FIG. 1B is a cutaway illustration revealing some interior features of the single dominating mode microwave reactor according to some embodiments of the invention.

FIG. 2 is a cutaway illustration revealing some interior features of the filtering means of the single dominating mode microwave reactor according to some embodiments of the invention.

FIG. 3 is a top view of a horn antenna comprising filtering means being part of the single dominating mode microwave reactor according to some embodiments of the invention.

FIG. 4 is a cross sectional view of the E-field in the direction of propagation of the microwaves inside the reactor the single dominating mode microwave reactor according to some embodiments of the invention.

FIG. 5 is a cross sectional view of the E-field orthogonal to the direction of propagation of the microwaves inside the single dominating mode microwave reactor according to some embodiments of the invention.

FIG. 6 is a schematic illustration of the single dominating mode microwave reactor having two horn antennas according to some embodiments of the invention.

FIG. 7 is a schematic illustration of the filtering means of a single dominating mode microwave reactor having two horn antennas according to some embodiments of the invention.

FIGS. 8A and 8B are cross sections of the filtering means of a single dominating mode microwave reactor having two horn antennas according to some embodiments of the invention.

FIGS. 9A and 9B are cross sections of the single dominating mode microwave reactor having two horn antennas according to some embodiments of the invention.

FIG. 10 is a schematic illustration of the single dominating mode microwave reactor system according to some embodiments of the second aspect of the invention.

FIG. 11 is a flow chart of the method of producing biofuel according to some embodiments of the third aspect of the invention.

### DETAILED DESCRIPTION OF AN EMBODIMENT

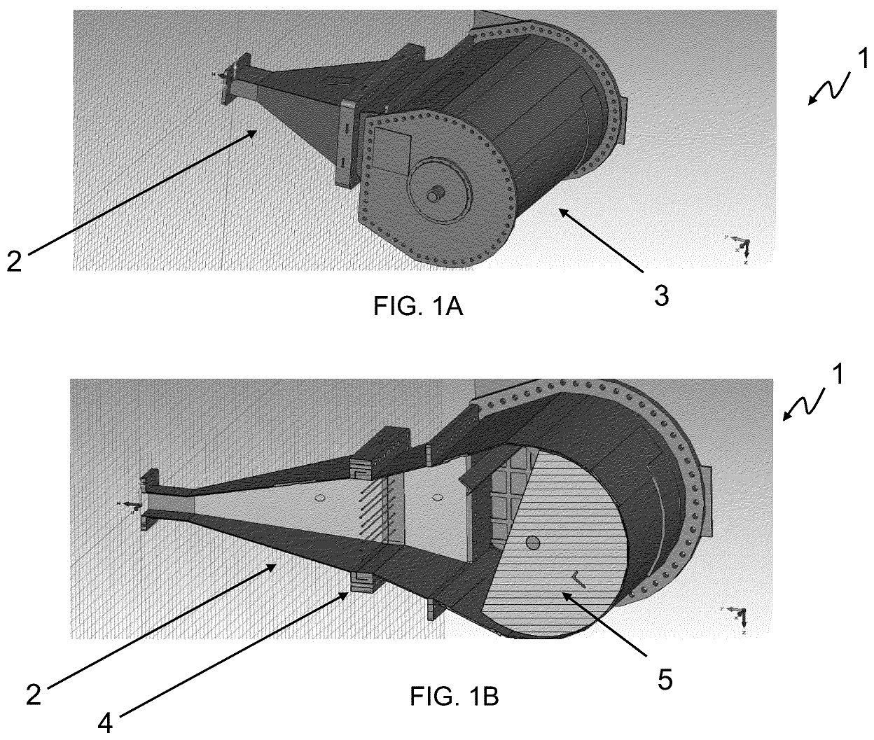

FIG. 1A depicts the single dominating mode microwave reactor 1, also referred as reactor, according to some embodiments of the invention.

The reactor 1 comprises a feed horn antenna 2 connected to a reactor chamber 3 which is cylindrical cavity where the reactions to be performed will occur. In that, the reactor chamber is a cylindrical bed for the material to be processed.

A rotating device may be located within the reactor chamber 3.

The rotating device may comprise helical blades attached to a rotating shaft intended for moving and turning the material to be processed located into the reactor chamber 3.

Simulations and tests have shown that this rotational device will not substantially disturb the electrical field.

The reactor may further comprise some inspection and measuring pipes that are not shown within the figures.

The interface to the horn Antenna 2 may be a WR340 waveguide, operating in its fundamental TE₁₀ mode at 2.45 GHz.

Inside the horn antenna 2, there is a mode filter 4 which, as shown in FIG. 1B, may comprise of metal cylinders or rods separated between each other.

The material 5 to be processed is also shown in FIG. 1B.

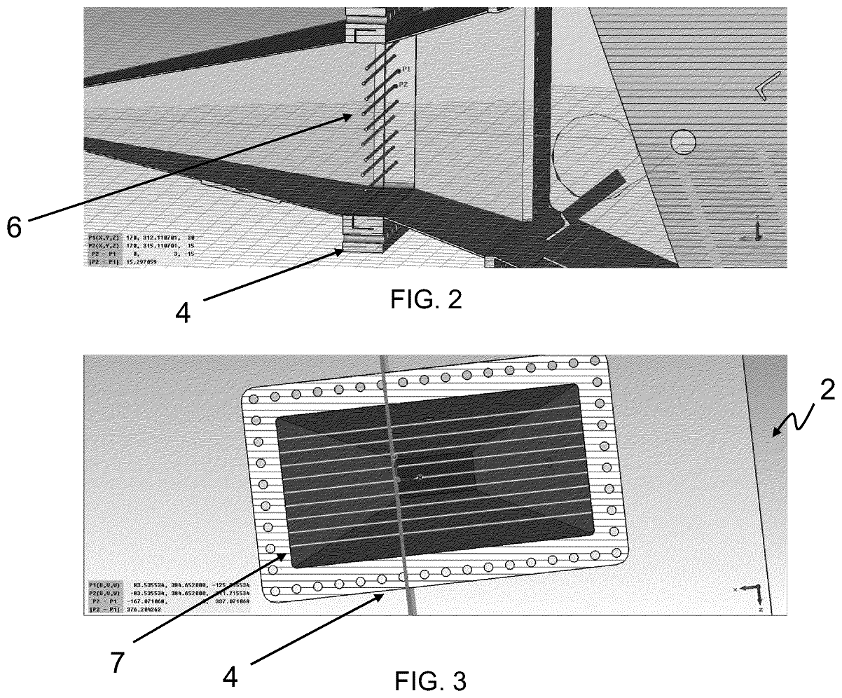

As shown in FIG. 2, the metal cylinder 6 may be separated between each other by several millimeters. For example, the metal cylinders may be separated by 15 mm in the y-direction, and by 3 mm in the direction of wave propagation, i.e. the z-direction.

At the mode filter 4 position, several over-modes can exist in a system without mode filter. The mode filter have the functions of cancelling or reducing the over modes that have an E-field component parallel with the metal cylinders 6 of the mode filter 4.

The mode filter 4 ensures that a quasi-plane wave, with the energy conserved in the direction of the TE₁₀ mode polarization in the WR340 waveguide propagates into the reactor chamber 3, shown in FIG. 1A.

FIG. 3 is a top view of a horn antenna 2 comprising filtering means 4.

FIG. 3 shows the mode filter 4 view into the reactor feed horn 2, towards the feed waveguide.

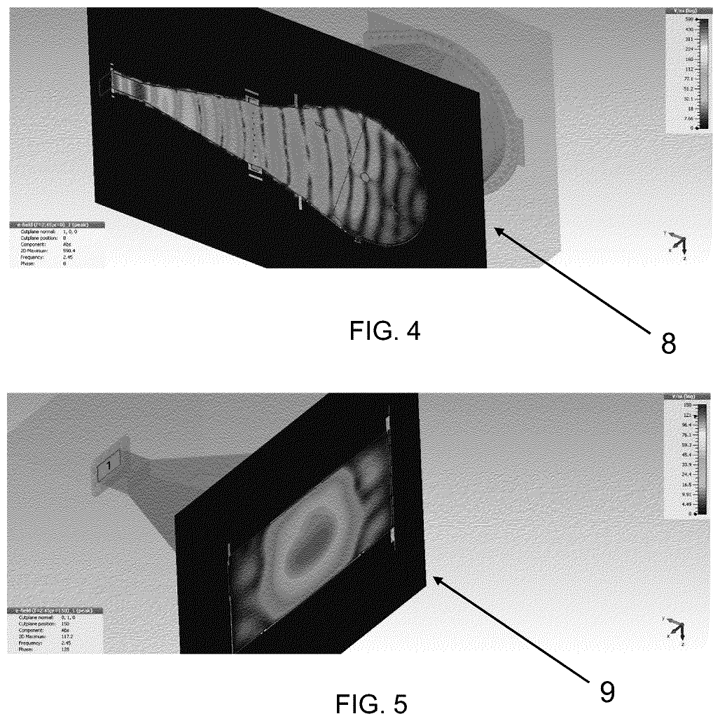

This construction ensures a uniform focus of energy and field direction onto the processed material in the bed as it can be seen from the FIG. 4 showing the cross sectional, i.e. y-z plane, view 8 in the direction of propagation of the E-field inside the reactor.

FIG. 5 shows a cross sectional, i.e. x-z plane, view 9 of the E-field orthogonal to the direction of propagation of the microwaves inside the single dominating mode microwave reactor according to some embodiments of the invention.

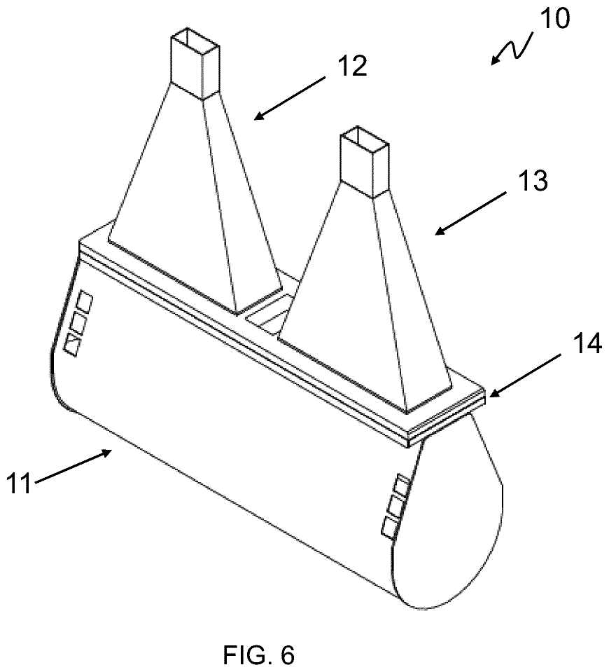

FIG. 6 is a schematic illustration of a different embodiment of the single dominating mode microwave reactor 10 according to some embodiments of the invention.

The single dominating mode microwave reactor 10 is characterized by the presence of two horn antennas 12 and 13.

A single mode filter 14 across both horn antennas 12 and 13 is used to ensure distribution of microwave energy evenly on to the surface of the material to be processed with the reactor chamber 11.

This construction has the advance of reducing complexity of two horn antennas system by having a single mode filter.

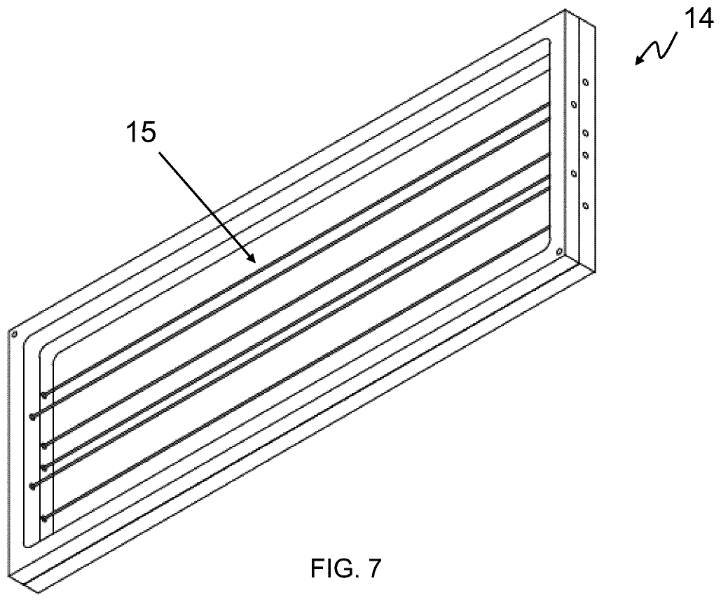

FIG. 7 is a schematic illustration of the filtering means or mode filter 14 for the single dominating mode microwave reactor 10 having two horn antennas 12 and 13.

The mode filter 14 may comprise of metal cylinders or rods 15 spaced from each other along the y and z axis.

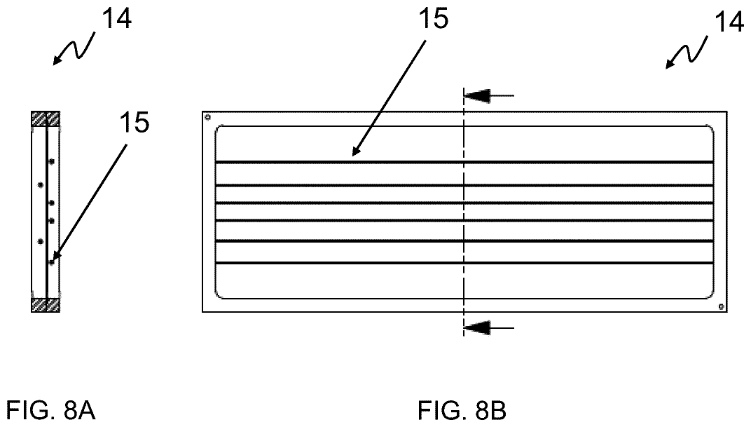

FIGS. 8A and 8B are cross sections of the filtering means or mode filter 14 showing the separation of the metal cylinders or rods 15 along the y and z axis of a single dominating mode microwave reactor 10 characterized by the presence of two horn antennas.

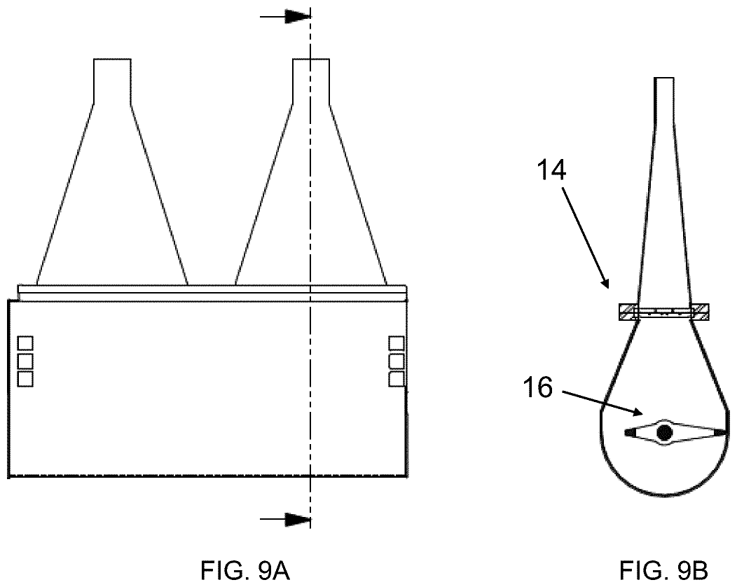

FIGS. 9A and 9B are cross sections of the single dominating mode microwave reactor 10 characterized by the presence of two horn antennas.

The presence of a rotating device 16 comprising helical blades attached to a rotating shaft intended for moving and turning the material to be processed located into the reactor chamber is shown in FIG. 9B.

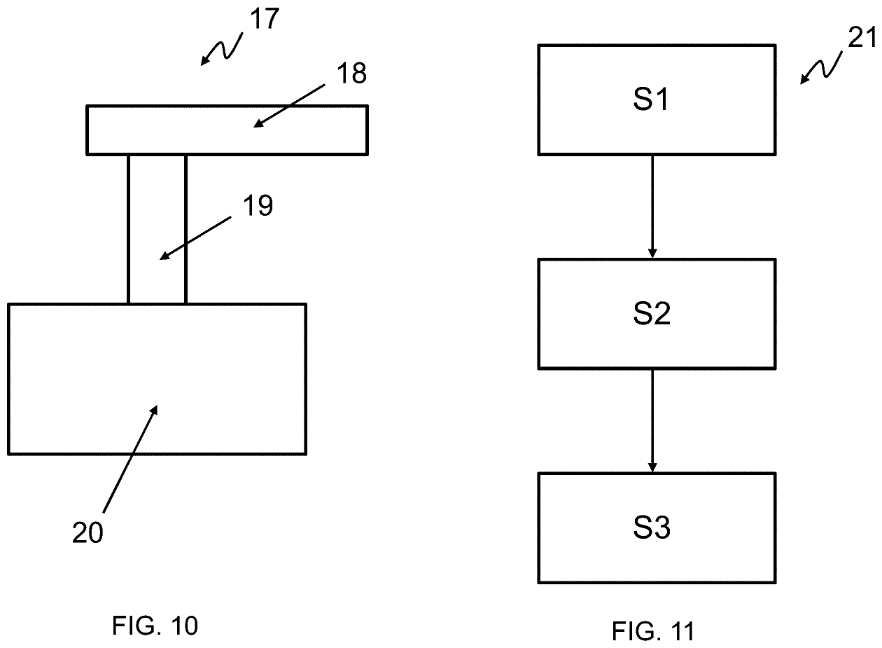

FIG. 10 is a schematic illustration of the single dominating mode microwave reactor system 17 comprising a single dominating mode microwave reactor chamber 20 and at least one means for feeding single mode microwaves 19 into the reactor chamber 20.

The reactor system 17 also comprises a microwave generator 18 feeding microwaves to the microwave reactor chamber 20 via the feeding means 19.

FIG. 11 is a flow chart of the method of producing biofuel according to some embodiments of the third aspect of the invention.

The method of producing biofuel 21 according to the third aspect of the invention may comprise the steps of:
S1, providing a feedstock;
S2, transferring the feedstock into a microwave reactor chamber of a microwave reactor or of a microwave reactor system;
S3, subjecting the feedstock to a processing sequence by applying microwave energy thereto.

The method allows for the generation of a uniformly distributed production of electrical field within the feedstock, thus avoiding the formation of hot spots and, in turn, providing a more efficient processing of the feedstock.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. In addition, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A single dominating mode microwave reactor, wherein said single dominating mode microwave reactor propagates microwaves in a TE₁₀ fundamental mode, said single dominating mode microwave reactor comprising:
a reactor chamber;
at least one antenna for feeding single mode microwaves into said reactor chamber connected to said reactor chamber, wherein said at least one antenna for feeding single mode microwaves comprises:
a transmitter configured to transmit microwaves, wherein the transmitter comprises a microwave inlet and a microwave outlet;
a filter, which comprises a mode filter and, wherein said mode filter comprises metal rods or cylinders separated from each other and located at the microwave outlet of the transmitter, wherein said metal rods or cylinders are separated from each other by less than a quarter wavelength of transmitted microwaves in the direction of propagation of the microwaves and by less than a half wavelength of transmitted microwaves in a direction orthogonal to the direction of propagation of the microwaves.

2-15. (canceled)

16. The single dominating mode microwave reactor according to claim 1, wherein said antenna comprises a horn antenna.

17. The single dominating mode microwave reactor according to claim 1, wherein said antenna comprises a microwave planar antenna.

18. The single dominating mode microwave reactor according to claim 1, wherein said reactor chamber is a cylindrical reactor chamber.

19. The single dominating mode microwave reactor according to claim 1, further comprising a rotating device located within said reactor chamber, said rotating device configured to mix the material to be processed within said reactor chamber, thereby ensuring uniform microwave radiation onto the material to be processed.

20. The single dominating mode microwave reactor according to claim 19, wherein said rotating device comprises an impeller.

21. The single dominating mode microwave reactor according claim 19, wherein said rotating device comprises helical blades attached to a rotating shaft.

22. A single dominating mode microwave reactor system comprising:
a single dominating mode microwave reactor according to claim 1; and
a microwave generator connected to said single dominating mode microwave reactor.

23. The single dominating mode microwave reactor system according to claim 22, wherein said system is a dual system.

24. A method of producing fuel, said method comprising:
providing a feedstock;
transferring said feedstock into a microwave reactor chamber of a microwave reactor according to claim 1; and
subjecting said feedstock to a processing sequence by applying microwave energy thereto, thereby producing an distributed generation of electrical field onto said feedstock.
